(19) United States
(12) Patent Application Publication
(10) Pub. No.: US 2021/0011952 A1
(43) Pub. Date: Jan. 14, 2021

(54) Generating Recommendations Using Biometric Data Detected by Internet of Things Sensors

(71) Applicant: International Business Machines Corporation, Armonk, NY (US)

(72) Inventors: Michael Bender, Rye Brook, NY (US); Rhonda L. Childress, Austin, TX (US); Kim A. Eckert, Austin, TX (US); Minh Q. Pham, Austin, TX (US); Stan Kevin Daley, Atlanta, GA (US)

(21) Appl. No.: 16/504,903

(22) Filed: Jul. 8, 2019

(51) Int. Cl. G06F 16/9032; G06F 16/9038; G06F 3/01

(52) U.S. Cl. CPC G06F 16/90328; G06F 3/015; G06F 16/9038

(57) ABSTRACT

A method, apparatus, system, and computer program product for identifying a recommendation for an activity. Biometric data for a set of biometric parameters is received for a user. A set of comparable users having saved biometric data for the set of biometric parameters that are comparable to the biometric data for the set of biometric parameters for a user is identified. The recommendation for the activity is determined based on prior recommendations from the set of comparable users for the activity. The recommendation for the activity is sent to a client device, wherein the client device displays the recommendation for the activity to the user.

### BACKGROUND

### 1. Field

The disclosure relates generally to an improved computer system and more specifically to a method, apparatus, computer system, and computer program product for generating recommendations for activities using biometric data detected by sensors in Internet of Things (IoT) client devices.

### 2. Description of the Related Art

When looking for an activity, users commonly search the Internet for ratings and reviews of different activities that are available. The rating or review of an activity can vary when made by people with different types of interests or different activity levels. These ratings and reviews are made by people who may view the same activity as having varying levels of enjoyment or difficulty depending on their interest or activity level. One individual may rate a walking tour through ancient ruins as easy while another individual may rate the same walking tour as difficult.

For example, a triathlon athlete who has participated in an activity that includes walking and climbing steps at ancient ruins may rate the activity as easy and not challenging. An average person, who is not a triathlon athlete, however, may find the same activity very challenging and, as a result, not as enjoyable.

Therefore, it would be desirable to have a method and apparatus that take into account at least some of the issues discussed above, as well as other possible issues. For example, it would be desirable to have a method and apparatus that overcome a technical problem with providing users with recommendations of difficulties or enjoyability of activities that correspond to their individual views of what activities are difficult or enjoyable.

### SUMMARY

According to one embodiment of the present invention, a method identifies a recommendation for an activity. Biometric data for a set of biometric parameters is received for a user. A set of comparable users having saved biometric data for the set of biometric parameters that are comparable to the biometric data for the set of biometric parameters for a user is identified. The recommendation for the activity is determined based on prior recommendations from the set of comparable users for the activity. The recommendation for the activity is sent to a client device, wherein the client device displays the recommendation for the activity to the user.

According to another embodiment of the present invention, a recommendation system comprises a computer system. The computer system receives biometric data for a set of biometric parameters for a user and identifies a set of comparable users having saved biometric data for the set of biometric parameters that are comparable to the biometric data for the set of biometric parameters for a user. The computer system determines a recommendation for an activity based on prior recommendations from the set of comparable users for the activity. The computer system sends the recommendation for the activity to a client device, wherein the client device displays the recommendation for the activity to the user.

According to yet another embodiment of the present invention, a computer program product for identifying a recommendation for an activity comprises a computer-readable-storage media with first program code, second program code, third program code, and fourth program code stored on the computer-readable storage media. The first program code is executed to receive biometric data for a set of biometric parameters for a user. The second program code is executed to run a set of comparable users having saved biometric data for the set of biometric parameters that are comparable to the biometric data for the set of biometric parameters for the user. The third program code is executed to determine the recommendation for the activity based on prior recommendations from the set of comparable users for the activity. The fourth program code is executed to send the recommendation for the activity to a client device, wherein the client device displays the recommendation for the activity to the user.

### BRIEF DESCRIPTION OF THE DRAWINGS

FIG. 1 is a pictorial representation of a network of data processing systems in which illustrative embodiments may be implemented;

FIG. 2 is a block diagram of a recommendation environment in accordance with an illustrative embodiment;

FIG. 3 is a block diagram of components used to identify comparable users in accordance with an illustrative embodiment;

FIG. 4 is a block diagram of a recommendation database used to identify a recommendation in accordance with an illustrative embodiment;

FIG. 5 is a flowchart of a process for identifying a recommendation for an activity in accordance with an illustrative embodiment;

FIG. 6 is a flowchart of a process for grouping users based on biometric data in accordance with an illustrative embodiment;

FIG. 7 is a flowchart of a process for identifying comparable users in accordance with an illustrative embodiment;

FIG. 8 is a flowchart of a process for identifying comparable users in accordance with an illustrative embodiment;

FIG. 9 is a flowchart of a process identifying a recommendation based on prior recommendations from comparable users in accordance with an illustrative embodiment; and

FIG. 10 is a block diagram of a data processing system in accordance with an illustrative embodiment.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The illustrative embodiments recognize and take into account a number of different considerations. For example, the illustrative embodiments recognize and take into account that recommendations for activities can be made using biometric data from users. The illustrative embodiments recognize and take into account that biometric data for biometric parameters for users can be collected and analyzed. The illustrative embodiments recognize and take into account that the biometric data for the parameters can be used to place users into groups based on ranges of values in the biometric data for the different biometric parameters. The illustrative embodiments recognize and take into account that a user desiring to obtain recommendations for an activity can be provided with prior recommendations from other users who have biometric data for biometric parameters that are similar to the user.

Thus, the illustrative embodiments provide a method, apparatus, system, and computer program product for identifying recommendations for activities. In one illustrative example, a recommendation is identified for an activity. Biometric data for a set of biometric parameters for a user is received. A set of comparable users having saved biometric data for the set of biometric parameters that are comparable to the biometric data for the set of biometric parameters for the user is identified. The recommendation for the activity is determined based on prior recommendations from the set of comparable users for the activity. The recommendation for the activity is sent to a client device, wherein the client device displays the recommendation for the activity to the user.

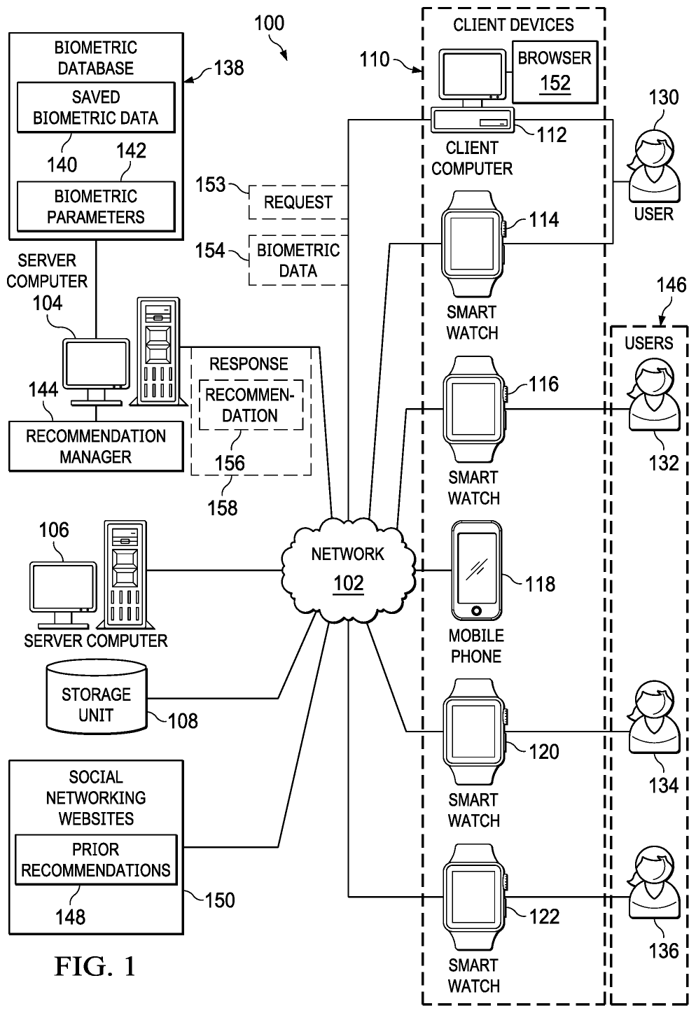

With reference now to the figures and, in particular, with reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client devices 110 connect to network 102. As depicted, client devices 110 include client computer 112, smart watch 114, and smart watch 116. Client devices 110 can be, for example, computers, workstations, or network computers. In the depicted example, server computer 104 provides information, such as boot files, operating system images, and applications to client devices 110. Further, client devices 110 can also include other types of client devices such as mobile phone 118, smart watch 120, and smart watch 122. In this illustrative example, server computer 104, server computer 106, storage unit 108, and client devices 110 are network devices that connect to network 102 in which network 102 is the communications media for these network devices. Some or all of client devices 110 may form an Internet of things (IoT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program code located in network data processing system 100 can be stored on a computer-recordable storage medium and downloaded to a data processing system or other device for use. For example, program code can be stored on a computer-recordable storage medium on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

As used herein, “a number of” when used with reference to items, means one or more items. For example, “a number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

In this illustrative example, user 130 wears smart watch 114. Further, user 132 wears smart watch 116, user 134 wears smart watch 120, and user 136 wears smart watch 122. These smart watches are examples of biometric data generation devices that operate to generate biometric data for biometric parameters. The biometric parameters can include at least one of a heart rate, a blood pressure, a temperature, a breathing rate, an oxygen level, or other suitable biometric parameter.

In this illustrative example, user 132, user 134, and user 136 are users 146 who have opted in to have their biometric data collected and stored in biometric database 138 as saved biometric data 140 for a set of biometric parameters 142 by recommendation manager 144.

As used herein, a “set of” when used with reference to items means one or more items. For example, “a set of biometric parameters 142” is one or more of biometric parameters 142.

As depicted, saved biometric data 140 is considered protected health information in the illustrative examples and can be collected from the smart watches for users 146 only when users 146 have provided consent for the collection and sharing of saved biometric data 140. In this illustrative example, the consent is obtained ahead of time with the proper disclosure and consent form that follow privacy rules and regulations, such as the Health Insurance Portability and Accountability Act of 1996. In the illustrative example, saved biometric data 140 is not collected or shared unless a user has opted in to share the information. Other information such as images, video data, and audio data of the user is personal and confidential information and is collected only with consent of the user to opt into this collection and usage of information.

In this illustrative example, recommendation manager 144 analyzes saved biometric data 140 for users 146, which includes user 132, user 134, and user 136 to group these users based on ranges of values in saved biometric data 140 for the set of biometric parameters 142. For example, the set of biometric parameters 142 can be a resting heart rate. Users 146 can be grouped based on the values of saved biometric data for a resting heart rate.

As depicted, user 132 has a resting heart rate of 60; user 134 has a resting heart rate of 66; and user 134 has a resting heart rate of 80. In this example, a first grouping of users have a resting heart rate in a range from 60 heartbeats per minute to 75 heartbeats per minute. A second grouping of users have a resting heart rate in a range from 76 heartbeats per minute to 90 heartbeats per minute. In this example, user 132 and user 134 are in the first grouping, and user 136 is in the second grouping.

As depicted, users 146 have made prior recommendations 148 for activities in which they have participated. In this illustrative, prior recommendations 148 are located on social networking websites 150 on network 102. A social networking website is a collection of related network web resources that are typically identified with a common domain name and published on at least one web server. The resources can include webpages, multimedia content, and other information. These resources are for online platforms which people use to build social networks or social relationships with other people. Although not shown, social networking websites 150 are located on server computers, storage systems, or other physical hardware connected to or part of network 102.

As depicted, user 130 operates browser 152 running on client computer 112 to request recommendations for a an activity. In this illustrative example, browser 152 sends request 153 for a recommendation for the activity selected by user 130. Request 153 is sent to recommendation manager 144. In this illustrative example, request 153 can be sent as a hypertext transfer protocol (HTTP) message that is generated by browser 152.

In this depicted example, user 130 also sends biometric data 154 to recommendation manager 144. Biometric data 154 is generated by smart watch 114 worn by user 130. In this illustrative example, biometric data 154 can be stored on client computer 112 and sent in request 153. In another illustrative example, biometric data 154 can be sent by smart watch 114 to recommendation manager 144. In yet another illustrative example, biometric data 154 generated by smart watch 114 can be stored on a server, such as server computer 106, or in storage unit 108. Biometric data 154 can be received by recommendation manager 144 requesting this data from server computer 106 or storage unit 108.

In this illustrative example, biometric data 154 for user 130 is not saved in biometric database 138 unless user 130 opts in and agrees and consents to the saving and use of biometric data 154. In this manner, user 130 can request a recommendation without having any personally identifiable information, such as biometric data 154, saved or used without expressed permission or consent following applicable privacy rules and regulations, such as the Health Insurance Portability and Accountability Act of 1996. In the illustrative example, health information, such as biometric data, is not collected or shared unless the user has opted in to share the information. Other information such as images, video data, and audio data of the user is personal and confidential information and is collected only with consent of the user to opt into this collection this collection and usage of information.

Recommendation manager 144 identifies a set of comparable users from users 146. In this example, biometric data 154 for user 130 includes a resting heartbeat rate of 68. Recommendation manager 144 determines that user 130 is part of the first group of users including user 132 and user 134. In this illustrative example, these two users are the comparable users to user 130.

As depicted, recommendation manager 144 determines recommendation 156 for the activity selected by user 130. Recommendation 156 is determined from prior recommendations 148 in social networking websites 150 made by the comparable users, user 132 and user 134. These prior recommendations were made by the comparable users after participating in the activity. The activity can be at the same location and time of year or can be at another location or time of year in these illustrative examples. Recommendation manager 144 returns recommendation 156 in response 158 to browser 152 in client computer 112. In this illustrative example, response 158 takes the form of a webpage that is displayed by browser 152 to user 130.

As result, user 130 is able to view prior recommendations 148 from comparable users. Other prior recommendations from other users who are not considered to be comparable based on biometric data are excluded in response 158. In this manner, user 130 uses prior recommendations 148 from users who have similar or comparable biometric data for a set of biometric parameters to determine whether user 130 is interested in participating in the activity.

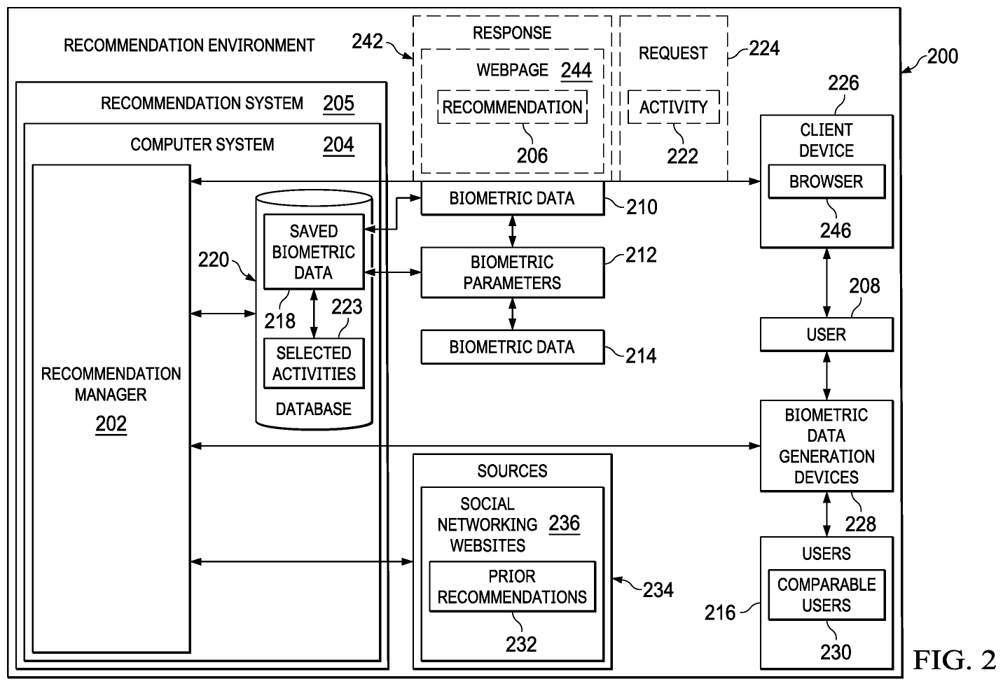

With reference now to FIG. 2, a block diagram of a recommendation environment is depicted in accordance with an illustrative embodiment. In this illustrative example, recommendation environment 200 includes components that can be implemented in hardware such as the hardware shown in network data processing system 100 in FIG. 1.

As depicted, recommendation manager 202 in computer system 204 operates as recommendation system 205 to provide recommendation 206 to user 208 based on biometric data 210 for a set of biometric parameters 212 for user 208. Recommendation manager 202 can be implemented in software, hardware, firmware, or a combination thereof. When software is used, the operations performed by recommendation manager 202 can be implemented in program code configured to run on hardware, such as a processor unit. When firmware is used, the operations performed by recommendation manager 202 can be implemented in program code and data and stored in persistent memory to run on a processor unit. When hardware is employed, the hardware may include circuits that operate to perform the operations in recommendation manager 202.

In the illustrative examples, the hardware may take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 204 is a physical hardware system and includes one or more data processing systems. When more than one data processing system is present in computer system 204, those data processing systems are in communication with each other using a communications medium. The communications medium can be a network. The data processing systems can be selected from at least one of a computer, a server computer, a tablet computer, or some other suitable data processing system.

In this illustrative example, biometric data 210 comprises values or other information for the set of biometric parameters 212. As depicted, biometric parameters 212 comprise at least one of a heart rate, a blood pressure, a temperature, a breathing rate, an oxygen level, or other suitable biometric parameters.

In this illustrative example, recommendation manager 202 receives biometric data 214 for users 216 with this data being saved as saved biometric data 218 in database 220. In this illustrative example, biometric data 210 for user 208 and biometric data 214 for users 216 are considered protected health information in the illustrative examples and can be collected from devices for the users only when the users have provided consent for the collection and sharing of their biometric data. In this illustrative example, the consent is obtained ahead of time with the proper disclosure and consent form that follow privacy rules and regulations, such as the Health Insurance Portability and Accountability Act of 1996. In the illustrative example, biometric data 210 is not collected or shared unless a user has opted in to share the information. Other information such as images, video data, and audio data of the user is personal and confidential information and is collected only with consent of the user to opt into this collection and usage of information.

In this illustrative example, users 216 have explicitly agreed and consented to have their biometric data saved as saved biometric data 218 for use in generating recommendation 206. User 208 has not consented to having biometric data 210 saved. However, user 208 has consented to sending biometric data 210 to recommendation manager 202 for temporary use in generating recommendation 206. In this illustrative example, biometric data 210 is not saved for future use and is only retained for generating recommendation 206 with biometric data 210. This data is deleted after generating recommendation 206.

Further, regardless of whether biometric data is used temporarily or saved, biometric data, such as biometric data 210 and saved biometric data 218, can be handled in a secure fashion. For example, the biometric data can be encrypted. As another example, tokenization can be used to obscure and hide the identity of user 208 and users 216. With tokenization, the data is removed and replaced with an undecipherable token that has no extrinsic or exploitable meaning or value.

In this illustrative example, database 220 is a collection of data or information. This data or information in database 220 can be organized for searching and retrieval. For example, database 220 can be a structured query language (SQL) database. Database 220 can also include the software program code used to search the data or information in database 220. In this example, any biometric or other protected data is stored using at least one of encryption, tokenization, or other data protection techniques.

In this illustrative example, biometric data 210 is received from computing devices for users 216. These computing devices can be selected from at least one of a smart watch, a mobile phone, an activity tracker, a fitness tracker, a smart wristband, a camera, Internet of Things (IoT) clothing, a wearable device, or other device that is capable of generating biometric data 210 about users 216 using sensors.

As depicted, recommendation manager 202 receives a selection of activity 222 from user 208. In this illustrative example, activity 222 is received in request 224 from client device 226 operated by user 208. Activity 222 can be selected as resting, walking, jogging, running, swimming, horseback riding, zip lining, snorkeling, scuba diving, rowing, golfing or other activities that may be of interest to user 208. These activities can have different levels of enjoyment depending on user 208. In some examples, the interest may determine a level of enjoyment.

In addition to receiving request 224, recommendation manager 202 also receives biometric data 210 for the set of biometric parameters 212 for user 208. In this illustrative example, biometric data 210 for the set of biometric parameters 212 can be used to determine a level of enjoyment for the user in making recommendation 206 for activity 222.

Biometric data 210 can be sent from client device 226 or a set of biometric data generation devices 228 carried by user 208. The set of biometric data generation devices 228 are physical hardware devices and can be selected from at least one of a smart watch, a mobile phone, an activity tracker, a fitness tracker, a smart wristband, a camera, Internet of Things (IoT) clothing, a wearable device, or some other suitable device that can generate biometric data 210 about user 208.

In this illustrative example, recommendation manager 202 identifies a set of comparable users 230 having saved biometric data 218 for the set of biometric parameters 212 that are comparable to biometric data 210 for the set of biometric parameters 212 for user 208. In this illustrative example, the set of comparable users 230 can be a subset of users 216. In other words, the set of comparable users 230 are one or more of users 216 that have saved biometric data 218 that is considered comparable to biometric data 210 for user 208 for the set of biometric parameters 212.

Further, recommendation manager 202 identifies the set of comparable users 230 having saved biometric data 218 for the set of biometric parameters 212 for a set of selected activities 223 that are comparable to biometric data 210 for the set of biometric parameters 212 for user 208 for the set of selected activities 223. In this illustrative example, the set of selected activities 223 comprises at least one of resting, walking, jogging, running, rowing, climbing, swimming, horseback riding, zip lining, snorkeling, scuba diving, rowing, golfing, or other suitable activities that can be used for identifying comparable users 230 in users 216.

For example, the set of biometric parameters 212 can be a resting heartbeat rate in which the selected activity is resting. In other words, the resting heartbeat rate is a heartbeat rate that can be identified for user 208 and users 216 at a resting state.

In this illustrative example, the determination of which ones of users 216 are comparable users 230 from the heartbeat rate when resting can be made using a policy. The policy comprises one or more rules that define what values or ranges of values of biometric data 210 are considered comparable. For example, ranges of values for resting heartbeat rates in saved biometric data 218 can be used to group users 216. The resting heartbeat rate for user 208 in biometric data 210 can be placed into a grouping based on ranges of values for resting heart beat rates. Users 216 having heartbeat rates in the same range as user 208 are considered comparable users 230. In this illustrative example, the biometric data for the resting heartbeat rates is used for comparison.

In another illustrative example, comparable users 230 can be identified from users 216 using statistical analysis. For example, standard deviation techniques can be used in which comparable users 230 are a grouping of users. This grouping of users can be generated based on a number of standard deviations away from a user such as user 208. In yet another illustrative example, a clustering model can be used to identify particular ones of users 216 that are more similar to user 208 then other users in users 216 as comparable users 230.

In other illustrative examples, other biometric parameters in biometric parameters 212 can be used in addition to or in place of a resting heartbeat. For example, a blood pressure, a temperature, or other biometric parameters can also be used in addition to or in place of the resting heartbeat rate. Further, other activities can be used in the set of selected activities. For example, the selected activities for comparison can be one or more of walking, running, swimming, or other suitable activities.

After comparable users 230 are identified, recommendation manager 202 determines recommendation 206 for activity 222 based on prior recommendations 232 from the set of comparable users 230 for activity 222. In these illustrative examples, prior recommendations 232 can be located in or retrieved from sources 234. In this illustrative example, sources 234 include social networking websites 236. Sources 234 can also include databases or other collections of data that may not be available on the Internet in addition to or in place of social networking websites 236. For example, prior recommendations 232 can be received directly by recommendation manager 202 or some other organization through email messages, product postings, or using other communication mechanisms.

As depicted, recommendation 206 and prior recommendations 232 can include one or more items. For example, recommendation 206 can include at least one of an enjoyment level, an activity level, a rating, a review, or other suitable information that can be used by user 208 to determine whether to participate in activity 222. For example, recommendation 206 can also include a more detailed description of activity 222. Further, recommendation 206 can be a positive or a negative in the illustrative examples.

In this illustrative example, recommendation manager 202 sends recommendation 238 for activity 222 to client device 226 in response 242. Client device 226 displays recommendation 206 for activity 222 to user 208. Recommendation 206 may be in webpage 244 sent to browser 246 running on client device 226. Browser 246 displays webpage 244 with recommendation 206. In this illustrative example, browser 246 is a software application for accessing information on the World Wide Web on the Internet. Browser 246 can be a standalone application or a component in another application such as a word processing application, a spreadsheet application, or a database application. Webpage 244 can include at least one of text, graphics, video, audio, or other media used to convey recommendation 206 to user 208.

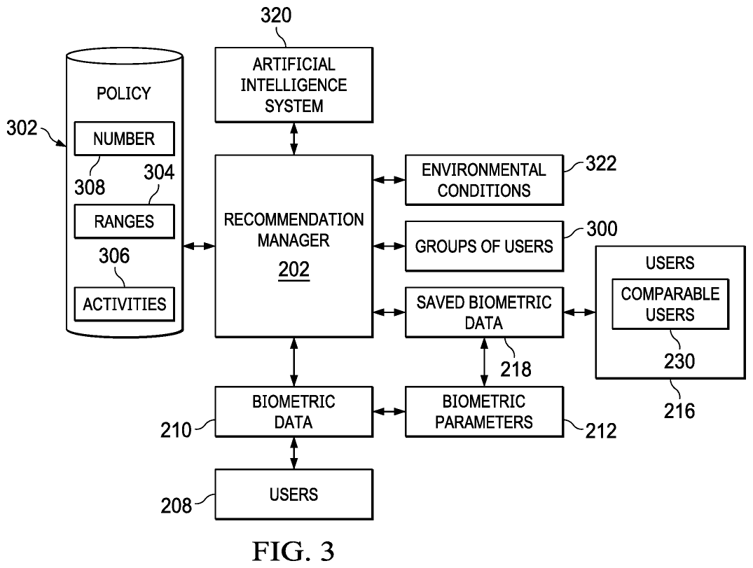

With reference next to FIG. 3, a block diagram of components used to identify comparable users is depicted in accordance with an illustrative embodiment. In the illustrative examples, the same reference numeral may be used in more than one figure. This reuse of a reference numeral in different figures represents the same element in the different figures.

In this illustrative example, recommendation manager 202 groups users 216 into groups of users 300 based on saved biometric data 218 for a set of biometric parameters 212 for users 216. As depicted, recommendation manager 202 can group users 216 into groups of users 300 using the values in saved biometric data 218 to place users 216 into groups of users 300 using policy 302. In this illustrative example, policy 302 is one or more rules that are used to group users 216 into groups of users 300. Policy 302 can also include data used to apply the rules.

In this illustrative example, policy 302 defines number 308 of biometric parameters 212 that are used to group users 216 into groups of users 300. Policy 302 also defines ranges 304 for each of the parameters used to place users 216 into groups of users 300. Policy 302 also defines a set of activities 306 for the set of biometric parameters 212. In other words, each biometric parameter in the set of biometric parameters 212 in policy 302 is associated with a particular activity in the set of activities 306.

In one illustrative example, policy 302 specifies a heart rate as the biometric parameter selected for the set of biometric parameters 212. Further, policy 302 also specifies that the activity is resting. As a result, saved biometric data 218 used to place users 216 into groups of users 300 are values for the heart rate when users 216 are resting. In other words, the heart rate is a resting heart rate for users 216. Policy 302 also specifies ranges 304 of values for resting heart rates for different groups of users 300.

Comparable users 230 from groups of users 300 can be identified for user 208 using policy 302. The same rules in policy 302 used to generate groups of users 300 can also be applied to biometric data 210 for a set of biometric parameters 212 for user 208 to place user 208 into a group in groups of users 300. For example, when the biometric parameter in the number of biometric parameters 212 is a heart rate and the activity in the set of activities 306 is resting, the resting heart rate for user 208 and biometric data 210 is used to place users 216 into groups of users 300 based on the ranges defined by policy 302. The group of users 216 in groups of users 300 that user 208 belongs to contains users 216 that are comparable users 230 for user 208. As used herein, a “group of” when used with reference to items, means one or more items. For example, a group of users is one or more users.

In another illustrative example, recommendation manager 202 can use statistical analysis to group users 216 into groups of users 300 instead of or in addition to using policy 302. This grouping can be performed using standard deviation techniques in which groupings are generated based on a number of standard deviations of saved biometric data 218 for users 216 away from biometric data 210 for user 208. Further, recommendation manager 202 can also use clustering analysis to identify comparable users 230 in users 216. This type of analysis can identify which ones of users 216 are more like user 208.

As yet another illustrative example, recommendation manager 202 can use statistical analysis to identify comparable users 230 without grouping users 216. Further, artificial intelligence system 320 can be utilized by recommendation manager 202 or implemented as part of recommendation manager 202 to perform the identification of comparable users 230.

Artificial intelligence system 320 is a system that has intelligent behavior and can be based on function of the human brain. An artificial intelligence system comprises at least one of an artificial neural network, a cognitive system, a Bayesian network, fuzzy logic, an expert system, a natural language system, a cognitive system, or some other suitable system. Machine learning is used to train the artificial intelligence system. Machine learning involves inputting data to the process and allowing the process to adjust and improve the function of the artificial intelligence system. A cognitive system is a computing system that mimics the function of a human brain.

Further, the identification of comparable users 230 can also take into account environmental conditions 322. Environmental conditions 322 are one or more conditions that can be used to select saved biometric data 218 and biometric data 210 for a set of biometric parameters 212 for comparison.

Thus, a set of environmental conditions 322 can be taken into account in addition to the set of activities 306 when analyzing saved biometric data 218 and biometric data 210. For example, the set of biometric parameters 212 can be a heart rate. The set of activities 306 can be running, and the set of environmental conditions 322 can be 75 degrees to 80 degrees and rain. With these parameters, heart rate values were generated while users 216 and user 208 were running in the rain with a temperature of 75 degrees to 80 degrees. These multiple parameters provide a multidimensional problem that can be solved using statistical analysis such as clustering implemented by artificial intelligence system 320 to identify comparable users 230 for user 208.

In this manner, a more refined identification of comparable users 230 can be performed and take into account environmental conditions 322 when saved biometric data 218 generated by users 216 and biometric data 210 was generated by user 208.

Further, the illustrative examples can use policy 302, artificial intelligence system 320, statistical analysis, or some combination thereof to identify comparable users 230. This combination may or may not involve grouping users 216 into groups of users 300 depending on the particular technique employed.

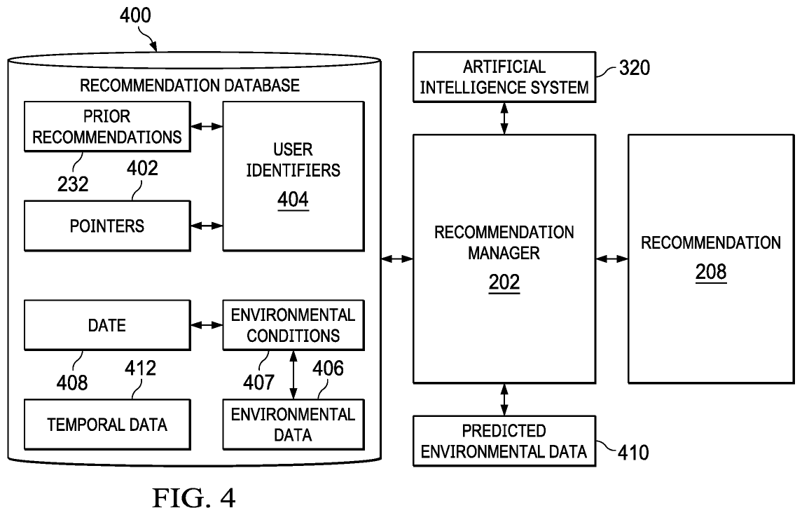

With reference next FIG. 4, a block diagram of a recommendation database used to identify a recommendation is depicted in accordance with an illustrative embodiment. In this illustrative example, recommendation database 400 can be used by recommendation manager 202 to identify recommendation 206. Recommendation database 400 includes at least one of prior recommendations 232 or pointers 402 to prior recommendations 232. Pointers 402 can be, for example, universal resource locators, inner protocol addresses, memory addresses, or other information used to point to the location of prior recommendations 232.

In this illustrative example, user identifiers 404 are identifiers for comparable users 230 identified for user 208. User identifiers 404 can be unique identifiers for each of comparable users 230 which are used to locate prior recommendations 232 made by comparable users 230.

Additionally, environmental data 406 for a set of environmental conditions 407 can also be used to identify prior recommendations 232 made by users 216. The set of environmental conditions 407 can be selected from at least one of a temperature, humidity, a sunburn index, precipitation, a windspeed, or other environmental data at the location in which the activity was performed by a comparable user from which the recommendation is made.

When environmental data 406 is present, user 208 can select date 408 for activity 222 that user 208 is considering. For example, with date 408 of when a comparable user performed an activity 222, a forecast or predicted weather for environmental conditions 407 is identified and can be used to identify predicted environmental data 410 for environmental conditions 407 for activity 222 selected by user 208. For example, with date 408, environmental data 406 for environmental conditions 407 such as temperature, humidity, precipitation, or other types of environmental data 406 can be predicted based on historical data for the location at which activity 222 is to be performed on date 408. Further, weather forecasting models also can be used by recommendation manager 202 to determine predicted environmental data 410 for activity 222.

As another illustrative example, temporal data 412 also can be considered in identifying prior recommendations 232. Temporal data 412 can be the duration of activity 222. For example, activity 222 can be a walking tour that lasts 30 minutes, one hour, three hours, or for some other period of time. Temporal data 412 can be used to identify prior recommendations 232 by comparable users of activity 222 that lasted for the same period of time.

When multiple factors such as biometric parameters, environmental data, and temporal data are present, prior recommendations 232 by comparable users 230 can be identified by searching recommendation database 400 in the form of a multidimensional model 414. Each dimension can represent a particular parameter of interest such as a biometric parameter and an environmental condition. In this illustrative example, artificial intelligence system 320 can be used by recommendation manager 202 to determine recommendation 206 from recommendation database 400.

In one illustrative example, one or more technical solutions are present that overcome a technical problem with identifying and providing users recommendations of difficulties or enjoyability of activities that correspond to their individual views of what activities are difficult or enjoyable. As a result, one or more illustrative examples provide one or more technical solutions that may provide a technical effect of identifying a recommendation for a user for an activity the user is considering. One or more illustrative examples provide one or more technical solutions in which biometric data for the user is used to identify comparable users having saved biometric data. The identification of these comparable users provides a technical solution in which prior recommendations from the comparable users can be identified and provided to the user such that a technical effect is present in which the user is able to more accurately determine whether the user would enjoy or be likely to participate in a particular activity.

Computer system 204 can be configured to perform at least one of the steps, operations, or actions described in the different illustrative examples using software, hardware, firmware or a combination thereof. As a result, computer system 204 operates as a special purpose computer system in which recommendation manager 202 in computer system 204 enables identifying prior recommendations from comparable users through comparing biometric data for a user considering an activity with saved biometric data for users to identify comparable users in the users. In particular, recommendation manager 202 transforms computer system 204 into a special purpose computer system as compared to currently available general computer systems that do not have recommendation manager 202.

In the illustrative example, the use of recommendation manager 202 in computer system 204 integrates processes into a practical application for identifying a recommendation for using biometric data. The illustrative example increases the performance of computer system 204 in identifying prior recommendations for activities that are more relevant to a particular user considering to participate in the activities. In other words, recommendation manager 202 in computer system 204 is directed to a practical application of processes integrated into recommendation manager 202 in computer system 204 that identifies prior recommendations 232 made by comparable users 230 based on saved biometric data 218 for comparable users 230 and biometric data 210 for user 208 considering participating in activity 222.

The illustration of recommendation environment 200 and the different components in FIGS. 2-4 are not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, other biometric parameters can be considered when identifying comparable users other than heart rate as described in one illustrative example. At least one of blood pressure, temperature, or other suitable biometric parameters can be used in addition to or in place of heart rate. Further, these parameters can be for activities other than resting. For example, the biometric data for these other biometric parameters can be for users walking, running, jumping, or performing other activities.

As another example, activity 222 can be activity part of a group of one or more activities. The group of activities can include multiple activities that are performed over a period of time such as during the day, several days, week, or some other period of time. A user can choose to participate in one or more activities in the group of activities.

In yet another illustrative example, client device 226 can be a biometric data generation device. For example, client device 226 can be a smart watch that includes software components such as browser 246.

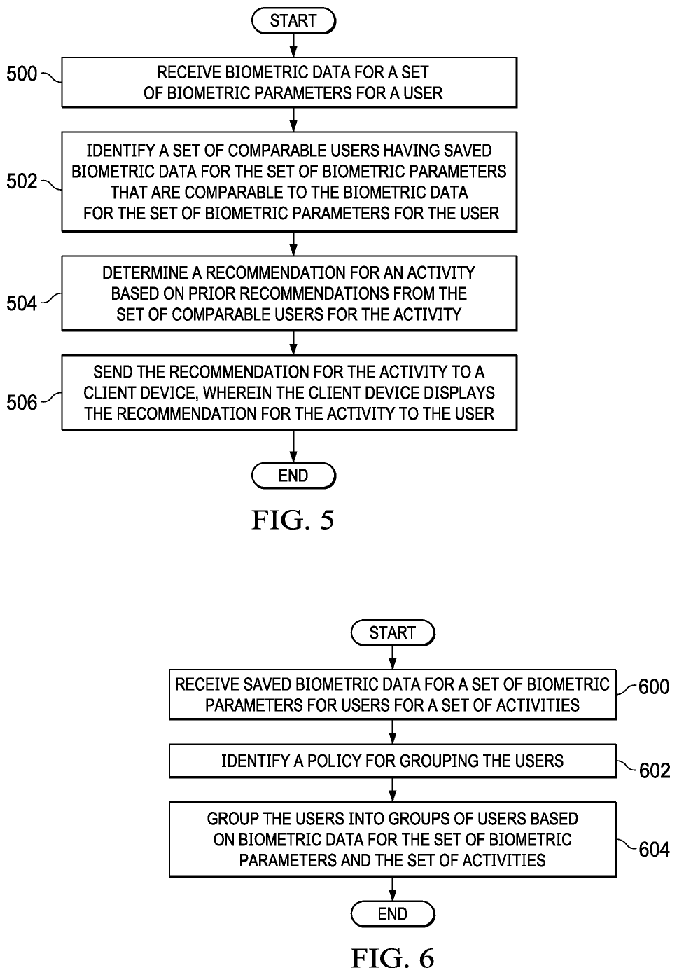

Turning next to FIG. 5, a flowchart of a process for identifying a recommendation for an activity is depicted in accordance with an illustrative embodiment. The process in FIG. 5 can be implemented in hardware, software, or both. When implemented in software, the process can take the form of program code that is run by one or more processor units located in one or more hardware devices in one or more computer systems. For example, the process can be implemented in recommendation manager 202 in computer system 204 in FIG. 2.

The process begins by receiving biometric data for a set of biometric parameters for a user (step 500). In step 500, the biometric data can be received in response to a request to a database in which biometric data for the user is stored. In another illustrative example, the biometric data can be sent from a client device operated by the user. In yet another illustrative example, the biometric data can be sent directly from a biometric data generation device such as a smart watch worn by the user.

The process identifies a set of comparable users having saved biometric data for the set of biometric parameters that are comparable to the biometric data for the set of biometric parameters for the user (step 502). The set of comparable users is one or more users who have saved biometric data for the set of biometric parameters that correspond sufficiently to the biometric data for the set of biometric parameters for the user. For example, if a value in the biometric data for a biometric parameter for the users having saved biometric data falls in the same range as the saved biometric data for the users, those users having values that fall in the same range for the biometric parameters are comparable users. Further, the values for the biometric data for the biometric parameter can also be based on the same activity.

For example, the biometric parameter can be heart rate and the activity can be a five-minute walk. Ranges of values for the heart rates can be used to group users into groups of users. A value for a heart rate for user considering participating in an activity can be placed into the group based on ranges. The users in the group are comparable users for purposes of identifying recommendations.

The process determines a recommendation for an activity based on prior recommendations from the set of comparable users for the activity (step 504). The process sends the recommendation for the activity to a client device, wherein the client device displays the recommendation for the activity to the user (step 506). The process terminates thereafter.

With the recommendation, the user can determine whether to participate or sign up for the activity. These prior recommendations used to generate the recommendation for the user can be more relevant to the user because the comparable users have biometric data that is similar enough to the biometric data for one or more biometric parameters for the user.

With reference now to FIG. 6, a flowchart of a process for grouping users based on biometric data is depicted in accordance with an illustrative embodiment. The process in FIG. 6 can be implemented in hardware, software, or both. When implemented in software, the process can take the form of program code that is run by one of more processor units located in one or more hardware devices in one or more computer systems. For example, the process can be implemented in recommendation manager 202 in computer system 204 in FIG. 2.

The process begins by receiving saved biometric data for a set of biometric parameters for users for a set of activities (step 600). The process identifies a policy for grouping the users (step 602). The policy can be, for example, policy 302 in FIG. 3. In this example, the policy can specify one or more biometric parameters that are used for grouping the users into groups of users. Further, the policy also can identify an activity in the set of activities for each biometric parameter in the set of biometric parameters. In other words, each biometric parameter has an activity for which the biometric data is to be considered.

In one illustrative example, heart rate can be a biometric parameter and the activity can be resting. The policy also identifies ranges of values for each biometric parameter to place users into groups. In this example, three groups are present. The first group has a heart rate from 40 heart beats per minute to 69 heart beats per minute. A second group has a heart rate from 70 heart beats per minute to 75 heart beats per minute. A third group has a heart rate in a range from 76 heart beats per minute to 100 heart beats per minute.

The process groups the users into groups of users based on biometric data for the set of biometric parameters and the set of activities (step 604). The process terminates thereafter.

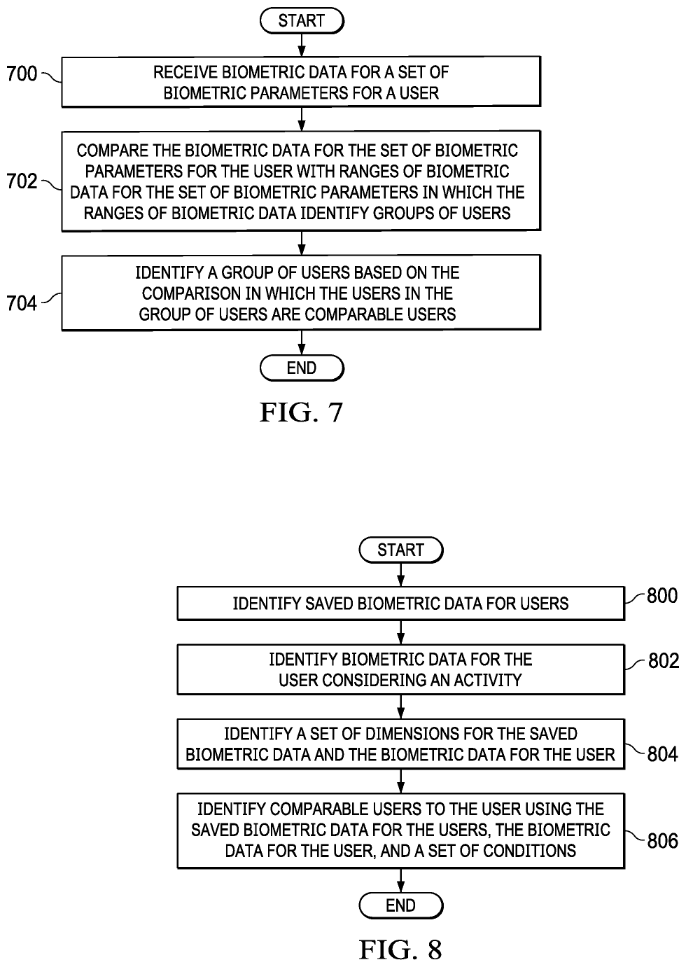

Turning next to FIG. 7, a flowchart of a process for identifying comparable users is depicted in accordance with an illustrative embodiment. The process in FIG. 7 can be implemented in hardware, software, or both. When implemented in software, the process can take the form of program code that is run by one of more processor units located in one or more hardware devices in one or more computer systems. For example, the process can be implemented in recommendation manager 202 in computer system 204 in FIG. 2.

The process begins by receiving biometric data for a set of biometric parameters for a user (step 700). The process compares the biometric data for the set of biometric parameters for the user with ranges of biometric data for the set of biometric parameters in which the ranges of biometric data identify groups of users (step 702). In step 702, the biometric data used can be biometric data for a particular activity. For example, the set of biometric parameters can be blood pressure with the activity being swimming. This biometric data is compared with ranges of biometric data for users in the groups of users for swimming.

Next, the process identifies a group of users in the groups of users based on the comparison in which the users in the group of users are comparable users (704). The process terminates thereafter.

Turning next to FIG. 8, a flowchart of a process for identifying comparable users is depicted in accordance with an illustrative embodiment. The process in FIG. 8 can be implemented in hardware, software, or both. When implemented in software, the process can take the form of program code that is run by one of more processor units located in one or more hardware devices in one or more computer systems. For example, the process can be implemented in recommendation manager 202 in computer system 204 in FIG. 2. In another illustrative example, this grouping can be performed using statistical analysis. For example, the groups of users can be determined by the number of standard deviations away from a user desiring to evaluate activity.

The process begins by identifying saved biometric data for users (step 800). The process then identifies biometric data for the user considering an activity (step 802).

The process identifies a set of dimensions for the saved biometric data and the biometric data for the user (step 804). For example, the set of dimensions can include one or more biometric parameters. The dimensions can also include one or more activities and one or more environmental conditions for use in selecting biometric data for analysis.

The process then identifies comparable users to the user using the saved biometric data for the users, the biometric data for the user, and a set of conditions (step 806). The process terminates thereafter. In step 806, this analysis can be performed using an artificial intelligence system. The artificial intelligence system can comprise a cognitive engine which is able to cluster users and identify comparable users to the user.

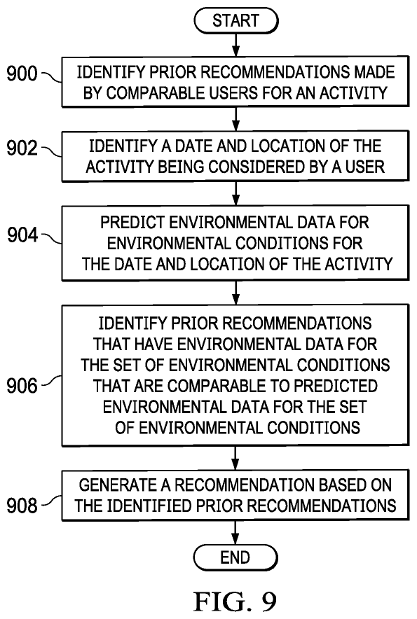

In FIG. 9, a flowchart of a process for identifying a recommendation based on prior recommendations from comparable users is depicted in accordance with an illustrative embodiment. The process in FIG. 9 can be implemented in hardware, software, or both. When implemented in software, the process can take the form of program code that is run by one of more processor units located in one or more hardware devices in one or more computer systems. For example, the process can be implemented in recommendation manager 202 in computer system 204 in FIG. 2.

The process begins by identifying prior recommendations made by comparable users for an activity (step 900). In step 900, the comparable users can be identified using the process illustrated in FIG. 7 or FIG. 8. The activity is one the user is considering to participate in or sign-up for as a participant. The process identifies a date and location of the activity being considered by a user (step 902). The process predicts environmental data for a set of environmental conditions for the date and the location of the activity (step 904). The set of environmental conditions can be, for example, at least one of a temperature, humidity, a sunburn index, precipitation, a windspeed, or other environmental data. The process identifies prior recommendations that have environmental data for the set of environmental conditions that are comparable to predicted environmental data for the set of environmental conditions (step 906).

The process then generates a recommendation based on the identified prior recommendations (step 908). The process terminates thereafter. The recommendation is based on the prior recommendations from the comparable users. The recommendation can be, for example, an enjoyment level, an activity level, a rating, a review, or other suitable recommendation information. For example, the recommendation can be an enjoyment level that is an average or aggregation of the enjoyment levels entered by the users. The recommendation can also include an activity level for the comparable users or individual activity levels identified by the comparable users. Further, the recommendation also may include reviews from the comparable users.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams can be implemented using special purpose hardware systems that perform the different operations or combinations of special purpose hardware and program code run by the special purpose hardware.

Thus, the illustrative examples can provide a recommendation for a user for an activity in various situations in which the recommendation is more likely to be of value to the user with the recommendation being based on biometric data for the user being compared to biometric data for other users who have performed the same activity. For example, a user is interested in touring the caves in Bermuda. The reviews for this activity are mostly very positive. Prior to choosing to participate in this activity, the user links the user's smart watch to a recommendation manager, such as recommendation manager 202 in FIG. 2. The recommendation manager determines that the user will find this activity challenging. This recommendation with a challenging rating is based on the increased heart rate, respiratory rates, and number of breaks for individuals with a similar condition having walked up the steps when touring the caves in Bermuda.

As another example, a user is planning a cruise and sees a kayaking activity that says the user needs to be in excellent shape. This user trained for triathlons. The biometric data for this user can be compared to biometric data of other users to identify comparable users to identify recommendations from other users in a similar situation. In this case, the recommendation indicates that this activity is very easy, and the user purchases a ticket for the kayaking activity.

In yet another example, a user considers going to a coastal resort but struggles in very humid weather. This user can send biometric data that is used by the recommendation manager to identify a recommendation based on comparable users. For example, this user can receive a recommendation that indicates an optimal time of the year to go to the coastal resort based on prior recommendations from comparable users.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

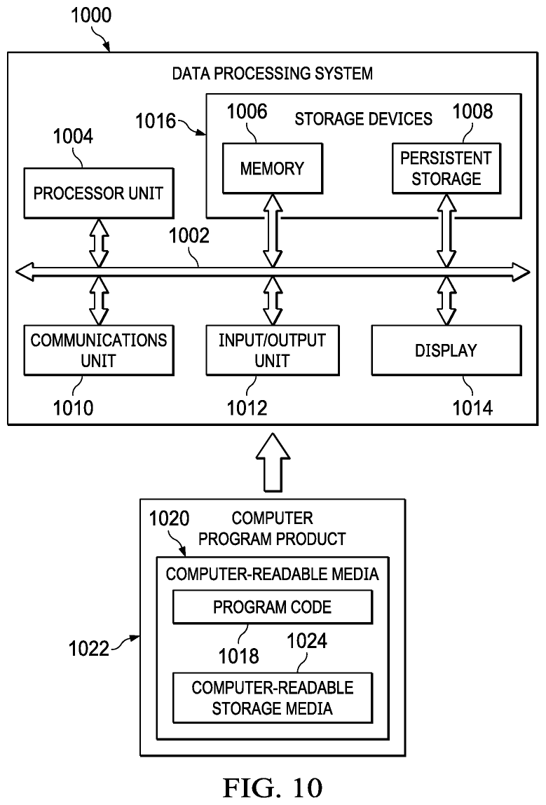

Turning now to FIG. 10, a block diagram of a data processing system is depicted in accordance with an illustrative embodiment. Data processing system 1000 can be used to implement server computer 104, server computer 106, client devices 110, in FIG. 1. Data processing system 1000 can also be used to implement one or more of computer system 204, client device 226, and biometric data generation devices 228 in FIG. 2. In this illustrative example, data processing system 1000 includes communications framework 1002, which provides communications between processor unit 1004, memory 1006, persistent storage 1008, communications unit 1010, input/output (I/O) unit 1012, and display 1014. In this example, communications framework 1002 takes the form of a bus system.

Processor unit 1004 serves to execute instructions for software that can be loaded into memory 1006. Processor unit 1004 includes one or more processors. For example, processor unit 1004 can be selected from at least one of a multicore processor, a central processing unit (CPU), a graphics processing unit (GPU), a physics processing unit (PPU), a digital signal processor (DSP), a network processor, or some other suitable type of processor. For example, further, processor unit 1004 can may be implemented using one or more heterogeneous processor systems in which a main processor is present with secondary processors on a single chip. As another illustrative example, processor unit 1004 can be a symmetric multi-processor system containing multiple processors of the same type on a single chip.

Memory 1006 and persistent storage 1008 are examples of storage devices 1016. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1016 may also be referred to as computer-readable storage devices in these illustrative examples. Memory 1006, in these examples, can be, for example, a random-access memory or any other suitable volatile or non-volatile storage device. Persistent storage 1008 may take various forms, depending on the particular implementation.

For example, persistent storage 1008 may contain one or more components or devices. For example, persistent storage 1008 can be a hard drive, a solid-state drive (SSD), a flash memory, a rewritable optical disk, a rewritable magnetic tape, or some combination of the above. The media used by persistent storage 1008 also can be removable. For example, a removable hard drive can be used for persistent storage 1008.

Communications unit 1010, in these illustrative examples, provides for communications with other data processing systems or devices. In these illustrative examples, communications unit 1010 is a network interface card.

Input/output unit 1012 allows for input and output of data with other devices that can be connected to data processing system 1000. For example, input/output unit 1012 may provide a connection for user input through at least one of a keyboard, a mouse, or some other suitable input device. Further, input/output unit 1012 may send output to a printer. Display 1014 provides a mechanism to display information to a user.

Instructions for at least one of the operating system, applications, or programs can be located in storage devices 1016, which are in communication with processor unit 1004 through communications framework 1002. The processes of the different embodiments can be performed by processor unit 1004 using computer-implemented instructions, which may be located in a memory, such as memory 1006.

These instructions are referred to as program code, computer usable program code, or computer-readable program code that can be read and executed by a processor in processor unit 1004. The program code in the different embodiments can be embodied on different physical or computer-readable storage media, such as memory 1006 or persistent storage 1008.

Program code 1018 is located in a functional form on computer-readable media 1020 that is selectively removable and can be loaded onto or transferred to data processing system 1000 for execution by processor unit 1004. Program code 1018 and computer-readable media 1020 form computer program product 1022 in these illustrative examples. In the illustrative example, computer-readable media 1020 is computer-readable storage media 1024.

In these illustrative examples, computer-readable storage media 1024 is a physical or tangible storage device used to store program code 1018 rather than a medium that propagates or transmits program code 1018.

Alternatively, program code 1018 can be transferred to data processing system 1000 using a computer-readable signal media. The computer-readable signal media can be, for example, a propagated data signal containing program code 1018. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

The different components illustrated for data processing system 1000 are not meant to provide architectural limitations to the manner in which different embodiments can be implemented. In some illustrative examples, one or more of the components may be incorporated in or otherwise form a portion of, another component. For example, memory 1006, or portions thereof, may be incorporated in processor unit 1004 in some illustrative examples. The different illustrative embodiments can be implemented in a data processing system including components in addition to or in place of those illustrated for data processing system 1000. Other components shown in FIG. 10 can be varied from the illustrative examples shown. The different embodiments can be implemented using any hardware device or system capable of running program code 1018.

Thus, illustrative embodiments of the present invention provide a computer implemented method, computer system, and computer program product for identifying recommendations for activities that a user is considering. Biometric data for a set of biometric parameters is received for a user. A set of comparable users having saved biometric data for the set of biometric parameters that are comparable to the biometric data for the set of biometric parameters for a user is identified. The recommendation for the activity is determined based on prior recommendations from the set of comparable users for the activity. The recommendation for the activity is sent to a client device, wherein the client device displays the recommendation for the activity to the user.

The illustrative examples overcome a problem with identifying and providing users recommendations of difficulties or enjoyability of activities that correspond to their individual views of what activities are difficult or enjoyable. As a result, one or more illustrative examples identify a recommendation for a user for activity the user is considering. One or more illustrative examples utilize biometric data for user to identify comparable users having saved biometric data. The identification of these comparable users enables identifying prior recommendations from the comparable users can be can be identified and provided to the user such the user is able to more accurately determine whether the user would enjoy or likely to participate in a particular activity.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A method for identifying a recommendation for an activity, the method comprising:
receiving, by a computer system, biometric data for a set of biometric parameters for a user;
identifying, by the computer system, a set of comparable users having saved biometric data for the set of biometric parameters that are comparable to the biometric data for the set of biometric parameters for a user;
determining, by the computer system, the recommendation for the activity based on prior recommendations from the set of comparable users for the activity; and
sending, by the computer system, the recommendation for the activity to a client device, wherein the client device displays the recommendation for the activity to the user.

2. The method of claim 1, wherein identifying, by the computer system, the set of comparable users having the saved biometric data for the set of biometric parameters that are comparable to the biometric data for the set of biometric parameters for the user comprises:
identifying, by the computer system, the set of comparable users having saved biometric data for the set of biometric parameters for a set of selected activities that are comparable to the biometric data for the set of biometric parameters for the user for the set of selected activities.

3. The method of claim 2, wherein the set of selected activities comprises at least one of resting, walking, jogging, running, rowing, climbing, swimming, horseback riding, zip lining, snorkeling, scuba diving, rowing, or golfing.

4. The method of claim 1, wherein determining, by the computer system, the recommendation for the activity based on the prior recommendations from the set of comparable users for the activity comprises:
determining, by the computer system, the recommendation for the activity based on the prior recommendations from the set of comparable users for the activity and environmental data for a set of environmental conditions for the activity.

5. The method of claim 1, wherein determining, by the computer system, the recommendation for the activity based on the prior recommendations from the set of comparable users for the activity comprises:
receiving, by the computer system, a selection of the activity that user is interested in participating;
identifying, by the computer system, the prior recommendations from comparable users for the activity; and
determining, by the computer system, the recommendation for the activity from the prior recommendations from the comparable users for the activity.

6. The method of claim 1 further comprising:
receiving, by the computer system, saved biometric data for the set of biometric parameters for users for a set of activities; and
grouping, by the computer system, the users into groups of users based on the biometric data for the set of biometric parameters and the set of activities for a set of environmental conditions.

7. The method of claim 1, wherein the recommendation is selected from at least one of an enjoyment level, an activity level, a rating, or a review.

8. The method of claim 1, wherein the set of biometric parameters comprises at least one of a heart rate, a blood pressure, a temperature, a breathing rate, or an oxygen level.

9. The method of claim 1, wherein the biometric data is received from at least one of a smart watch, a mobile phone, an activity tracker, a fitness tracker, a smart wristband, a camera, an Internet of Things clothing, or a wearable device.

10. A recommendation system comprising:
a computer system that:
receives biometric data for a set of biometric parameters for a user;
identifies a set of comparable users having saved biometric data for the set of biometric parameters that are comparable to the biometric data for the set of biometric parameters for a user;
determines a recommendation for an activity based on prior recommendations from the set of comparable users for the activity; and
sends the recommendation for the activity to a client device, wherein the client device displays the recommendation for the activity to the user.

11. The recommendation system of claim 10, wherein in identifying, by the computer system, the set of comparable users having saved biometric data for the set of biometric parameters that are comparable to the biometric data for the set of biometric parameters for the user, the computer system identifies the set of comparable users having saved biometric data for the set of biometric parameters for a set of selected activities that are comparable to the biometric data for the set of biometric parameters for the user for the set of selected activities.

12. The recommendation system of claim 11, wherein the set of selected activities comprises at least one of resting, walking, jogging, running, or swimming.

13. The recommendation system of claim 10, wherein in determining the recommendation for the activity based on the prior recommendations from the set of comparable users for the activity, the computer system determines the recommendation for the activity based on the prior recommendations from the set of comparable users for the activity and environmental data for a set of environmental conditions for the activity.

14. The recommendation system of claim 10, wherein in determining the recommendation for the activity based on the prior recommendations from the set of comparable users for the activity, the computer system receives a selection of the activity that user is interested in participating; identifies the prior recommendations from comparable users for the activity; and determines the recommendation for the activity from the prior recommendations from the set of comparable users.

15. The recommendation system of claim 10, wherein the computer system receives the saved biometric data for users for a plurality of activities and groups the users into groups of users based on the biometric data for the set of biometric parameters.

16. The recommendation system of claim 10, wherein the recommendation is selected from at least one of an enjoyment level, an activity level, a rating, or a review.

17. The recommendation system of claim 10, wherein the set of biometric parameters comprises at least one of a heart rate, a blood pressure, a temperature, a breathing rate, or an oxygen level.

18. A computer program product for identifying prior recommendations for an activity, the computer program product comprising:
a computer-readable storage media;
first program code, stored on the computer-readable storage media, for receiving biometric data for a set of biometric parameters for a user;
second program code, stored on the computer-readable storage media, for identifying a set of comparable users having saved biometric data for the set of biometric parameters that are comparable to the biometric data for the set of biometric parameters for the user;
third program code, stored on the computer-readable storage media, for determining a recommendation for the activity based on the prior recommendations from the set of comparable users for the activity; and
fourth program code, stored on the computer-readable storage media, for sending the recommendation for the activity to a client device, wherein the client device displays the recommendation for the activity to the user.

19. The computer program product of claim 18 wherein the second program code comprises:
program code, stored on the computer-readable storage media, for identifying the set of comparable users having saved biometric data for the set of biometric parameters for a set of selected activities that are comparable to the biometric data for the set of biometric parameters for the user for the set of selected activities.

20. The computer program product of claim 18, wherein the third program code comprises:
program code, stored on the computer-readable storage media, for determining the recommendation for the activity based on the prior recommendations from the set of comparable users for the activity and environmental data for a set of environmental conditions for the activity.
